(19) United States
(12) Patent Application Publication
(10) Pub. No.: US 2026/0296514 A1
(43) Pub. Date: Oct. 1, 2026

(54) PLATFORM LIFTING AND MOVING MECHANISM AND COMBINED PLATFORM

(71) Applicant: Suzhou Zhongchuang Aluminum Co., Ltd., Suzhou (CN)

(72) Inventors: Xiaoying Zhou, Suzhou (CN); Minghua Bao, Suzhou (CN); Lujiang Xue, Suzhou (CN)

(21) Appl. No.: 19/190,313

(22) Filed: Apr. 25, 2025

(30) Foreign Application Priority Data
Mar. 26, 2025 (CN) 202510362888.1

(51) Int. Cl. B62B 3/06; E06C 1/39

(52) U.S. Cl. CPC B62B 3/0606; B62B 3/0631; E06C 1/39; B62B 2206/003; B62B 2206/06; B62B 2301/044

(57) ABSTRACT

The present application discloses a platform lifting and moving mechanism and a combined platform capable of holding a platform, the combined platform comprising: a platform, the platform comprising multi-level steps; a platform lifting and moving mechanism, the platform lifting and moving mechanism comprising: a lifting body fixedly connected to the platform, which is provided with a parallel four-link structure and a rolling member; a puller assembly connected to the lifting body; the puller assembly being maneuverable to raise or lower the rolling member via the parallel four-link structure; wherein the puller assembly also has a locking member fixedly connected to the front end of the puller assembly; the locking member being capable of being blocked by the front end of the platform's steps in order to maintain a working state in which the platform lifting and moving mechanism carries the platform.

### CROSS-REFERENCE TO RELATED APPLICATION

This application claims priority of Chinese Patent Application No. 202510362888.1, filed on Mar. 26, 2025, the entire contents of which are incorporated herein by reference.

### TECHNICAL FIELD

The present application relates to an auxiliary lifting mechanism, and in particular to a platform lifting and moving mechanism and a combined platform.

### BACKGROUND

Combined platforms are used in many elevation scenarios, but they are basically fixed, and it is difficult to realize lifting mainly because of their large size and heavy weight.

In order to solve this problem, the utility model patent announcement number CN217297113U has disclosed a mechanism for platform lifting control and a lifting platform, by using a parallel four-link structure and a puller to assist manual lifting and transferring operations of the combined platform, but in the process of using the mechanism, it is found that the lifting state is often misinterpreted in the process of lifting and transferring, which not only affects the process of the operation but is also likely to cause safety accidents.

In addition, when lifting and lowering operation is carried out by pulling the handles, the moving wheels on both sides are prone to asynchronous lifting and lowering problems, which affects the moving efficiency and easily causes safety problems such as side tilting.

### SUMMARY

The inventor studied and found that the existing lifting mechanism is also set with locking piece, but the locking piece itself is movable on the tie rod assembly, the movable connection leads to the locking piece itself is not securely fixed in place, which is easy to dislocate resulting in lifting state release; further research found that the lifting state misinterpretation often happened when the ground is not level and passing through the cable and other obstacles, the obstacles will give the universal wheel a certain degree of obstruction force, and this force can just prompt the base to lift up, which will be transmitted to the puller assembly, causing the puller assembly to be unlocked and retracted, and the whole structure will be vibrated to a certain extent when passing through the obstacles, and this kind of vibration will be transmitted to the puller assembly, prompting the locking piece on the puller assembly will carry out the non-expected upward movement same, and this kind of upward movement once occurs, even if it's slight, because of the platform's super large weight, the current stabilized state will be quickly broken, and the puller assembly will quickly retreat, resulting in the lifting being released and the platform quickly landing.

Furthermore, the left and right sides of the handrail of the existing lifting mechanism respectively adopt two connecting rods to connect the lifting base below, and the two connecting rods are independent of each other, and thus it is difficult to ensure complete synchronization of the left and right sides due to the excessive weight of the platform when lifting or descending.

In order to solve at least one of the above problems, the present application adopts the following technical solution:
a platform lifting and moving mechanism, a platform comprising multi-level steps; the platform lifting and moving mechanism comprising:
a lifting body for fixedly connecting the platform, which is provided with a parallel four-link structure and a rolling member;
a puller assembly connected to the lifting body; the puller assembly being maneuverable to raise or lower the rolling member via the parallel four-link structure; wherein the puller assembly also has a locking member fixedly connected to the front end of the puller assembly; the upper end of the locking member being fixedly connected to the puller assembly; and wherein the locking member is capable of being blocked by the front end of the platform's steps in order to maintain a working state in which the platform lifting and moving mechanism carries the platform.

As one aspect of the present application, a hooking portion is provided at the lower end of the locking member; when the platform lifting and moving mechanism is in the working state, the hooking portion is located below the front end of the steps.

A platform lifting and moving mechanism, a platform comprising multi-level steps; the platform lifting and moving mechanism comprising:
a lifting body for fixedly connecting the platform, which is provided with a parallel four-link structure and a rolling member;
a puller assembly connected to the lifting body; the puller assembly being maneuverable to raise or lower the rolling member via the parallel four-link structure; wherein the puller assembly also has a locking member fixedly connected to the front end of the puller assembly; the upper end of the locking member being fixedly connected to the puller assembly, the lower end of the locking member having a hooking portion;
wherein the platform lifting and moving mechanism is in the working state in which the platform is movably carried, the locking member is blocked from contact with the front end of the steps, and the hooking portion is located below the front end of the steps; the puller assembly in such working state is permitted to be pulled forward a predetermined distance in order to move the hooking portion out from underneath the steps to an unobstructed unlocking state; when the hooking portion is in the unlocking state, the puller assembly is allowed to be maneuverable to rotate upwards.

As one aspect of the present application, the locking member comprises a locking plate; the hooking portion is an inner hook body provided at a lower end of the locking plate; the locking plate and the inner hook body are of one-piece molded construction; and an upper end of the locking plate is welded to the puller assembly.

A combined platform, comprising:
a platform, the platform comprising multi-level steps;
a platform lifting and moving mechanism, the platform lifting and moving mechanism comprising:
a lifting body fixedly connected to the platform, which is provided with a parallel four-link structure and a rolling member;
a puller assembly connected to the lifting body; the puller assembly being maneuverable to raise or lower the rolling member via the parallel four-link structure; wherein the puller assembly also has a locking member fixedly connected to the front end of the puller assembly; the locking member being capable of being blocked by the front end of the platform's steps in order to maintain a working state in which the platform lifting and moving mechanism carries the platform.

As one aspect of the present application, the platform lifting and moving mechanism can adopt the platform lifting and moving mechanism as described above.

Advantages of this disclosure exist in that:

The platform lifting and moving mechanism utilizes the gravity of the platform itself to maintain the state in which it is lifted without being able to be unlocked, and even if an obstacle or an uneven road surface causes the puller assembly to retract during walking, the puller assembly, because of the existence of the hooking portion, is maintained in the working state position, and no undesired shifting occurs, and thus the platform's load-bearing moving state can be maintained.

### BRIEF DESCRIPTION OF THE DRAWINGS

FIG. 1 is a three-dimensional structural diagram of a platform lifting and moving mechanism of an embodiment of the present application;

FIG. 2 is another view of FIG. 1;

FIG. 3 is a side view of FIG. 1;

FIG. 4 is an enlarged view of part X of FIG. 1;

FIG. 5 is an enlarged view of part Y of FIG. 3;

FIG. 6 is a three-dimensional structural diagram of a platform raised using FIG. 1;

FIG. 7 is another view of FIG. 6;

FIG. 8 is an enlarged view of part Z of FIG. 6;

FIG. 9 is a schematic diagram of the structure of the platform lifting and moving mechanism in a working state (A state);

FIG. 10 is a partially enlarged view of FIG. 9;

FIG. 11 is a schematic diagram of the platform lifting and moving mechanism switching from an unlocking state (B state) to a completed unlocking state (C state);

FIG. 12 is a schematic diagram of a connecting rod of the platform lifting and moving mechanism in a lying state;

FIG. 13 is a structural diagram of the platform lifting and moving mechanism of another embodiment of the present application;

FIG. 14 is a schematic diagram of the structure of the lifting assembly shown in one embodiment of the present application in an initial state;

FIG. 15 is a schematic diagram of the structure of a lifting state of FIG. 14;

FIG. 16 is a schematic diagram of the structure of FIG. 14 used in a platform;

FIG. 17 is a schematic diagram of the structure of FIG. 15 used in a platform;

FIG. 18 is a three-dimensional structural diagram of a combined platform having FIG. 1 and FIG. 14.

### DETAILED DESCRIPTION OF THE INVENTION

In order to enable those in the art to better understand the technical solutions in the present application, the technical solutions in the embodiments of the present application will be described clearly and completely in the following in conjunction with the accompanying drawings in the embodiments of the present application, and it is obvious that the described embodiments are only a part of the embodiments of the present application and not all of the embodiments. Based on the embodiments in this application, all other embodiments obtained by a person of ordinary skill in the art without making creative labor should fall within the scope of protection of this application.

It should be noted that when an element is the to be “set on” another element, it may be directly on the other element or may also be present centered on the other element. When an element is the to be “connected” to another element, it may be directly connected to the other element or there may be a centered other element. The terms “vertical”, “horizontal”, “left”, “right” and similar expressions used herein are for illustrative purposes only and are not intended to be used in any way.

It should be understood that “mounted”, “connected”, “coupled” should be understood in a broad sense, for example, may be a fixed connection, a removable connection, or a connection in one piece; it may be a mechanical connection or an electrical connection; it may be a direct connection or an indirect connection through an intermediate medium, or it may be a connection within the two elements. However, the words may be replaced by other expressions if other words can achieve the same purpose.

It should be noted that the combined platforms (e.g., large ladders, A-frame ladder, combination scaffolds, etc.) are used in many ascent scenarios, wherein staff members are required to stand on large platforms to carry out operations, and thus the large platforms are basically fixed. The combined platform is large and heavy, and it is difficult to be lifted to change its height. Embodiments of the present application provide a mechanism for platform lifting control, which is used for assembling on a large platform, so that the large platform can be lifted upwards and the height of the platform can be adjusted.

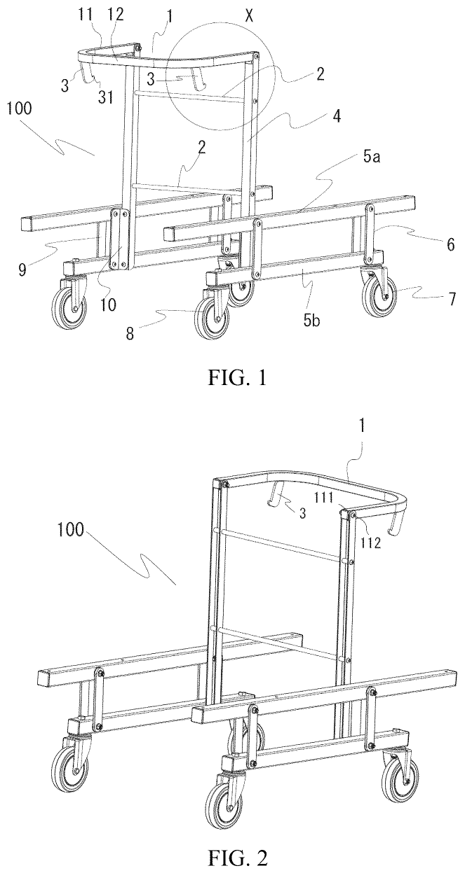

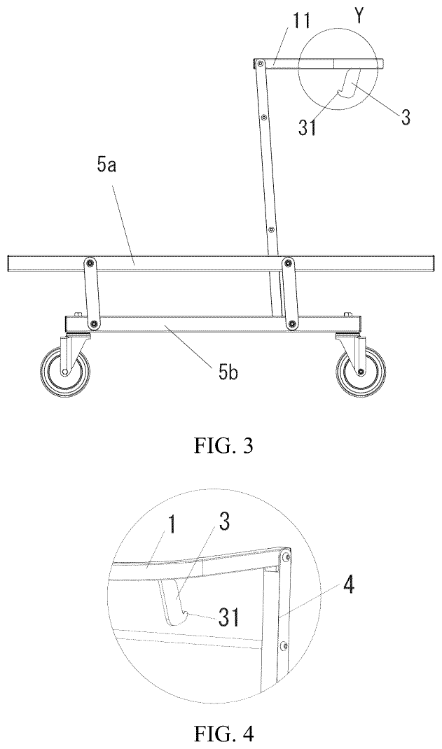

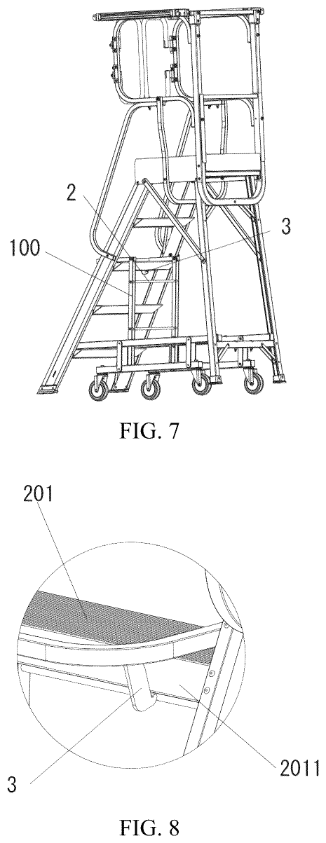

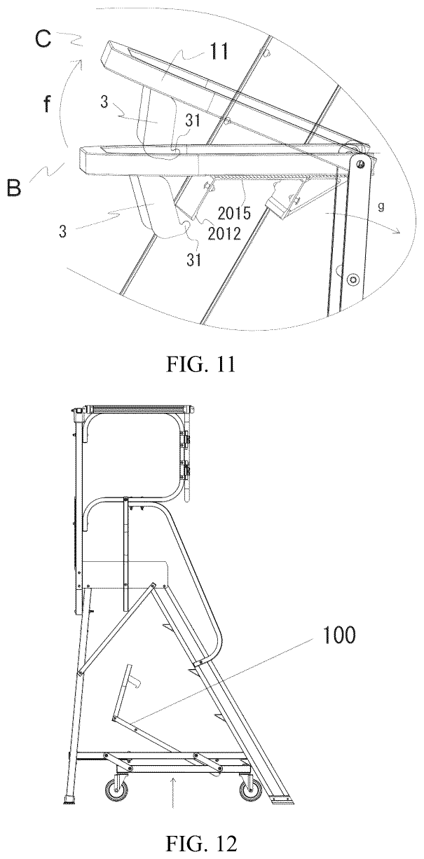

The platform lifting and moving mechanism 100 involved in the embodiments of the present application will be described in detail below in connection with FIG. 1 to FIG. 13. It should be noted that the following embodiments are only for explaining the present application and do not constitute a limitation of the present application.

As shown in FIG. 1 to FIG. 12, the present application provides a platform lifting and moving mechanism 100, the platform comprising multi-level steps 201. The platform lifting and moving mechanism 100 comprises: a lifting body connected to the platform, which is provided with a parallel four-link structure; and a puller assembly 1 connected to the lifting body via a connecting rod 4. The puller assembly 1 can be maneuverable to raise or lower a rolling member via the parallel four-link structure, thereby realizing the lifting or lowering of the platform.

The lifting body comprises: a platform connecting frame 5a for fixedly connecting the platform and a lifting base frame 5b connected in parallel below the platform connecting frame 5a. The lifting base frame 5b is connected to the platform connecting frame 5a by the parallel four-link structure and moves up and down with respect to the platform connecting frame 5a by the parallel four-link structure; the lifting base frame 5b is also provided with the rolling member.

The puller assembly 1 is connected to the parallel four-link structure by a connecting rod 4, which is capable of utilizing the parallel four-link structure to drive the lifting base frame 5b up and down with respect to the platform connecting frame 5a, whereby the platform is lifted or lowered. The rear end of the puller assembly 1 is rotatably connected to the upper end of the connecting rod 4. The puller assembly 1 also has a locking member 3 fixedly connected to the front end of the puller assembly 1; the upper end of the locking member 3 is fixedly connected to the puller assembly 1, and the lower end of the locking member 3 is provided with a hooking portion 31.

When the platform lifting and moving mechanism 100 is in the working state of movably carrying the platform, the puller assembly 1 spans over the top of a step 201, and the locking member 3 is blocked in contact with the front end 2011 of the step 201 to maintain the current state of the platform lifting and moving mechanism 100, at which time the hooking portion 31 is located underneath the front end 2011 of the step 201; in the working state the puller assembly 1 can be manipulated to pull forward (by a predetermined distance) to move the hooking portion 31 out from underneath step 201 to an unobstructed unlocking state; the hooking portion 31 in the unlocking state permits the puller assembly 1 to be manipulated to flip upwardly, at which time the lifting base frame 5b lifts up under the gravitational force of the platform, and the platform descends to the ground on its own.

The platform is carried on the platform lifting and moving mechanism 100, and the gravity of the platform presses down on the lifting base frame 5b, which in turn pulls back the puller assembly 1 by the connecting rod 4, forcing the locking member 3 to contact with the front end 2011 of the step 201 to be stopped, maintaining the current state of the platform lifting and moving mechanism 100, so that the platform lifting and moving mechanism 100 utilizes the gravity of the platform itself to maintain the state of being lifted without being able to be unlocked. Even if an obstacle or an uneven road surface causes the puller assembly to retract during walking, the puller assembly, because of the existence of the hooking portion 31, is maintained in the working state position, and no undesired shifting occurs, and thus the platform's load-bearing moving state can be maintained.

It is to be noted that the front, back, left, right, up and down orientation of the present application is based on the orientation of the combined platform in normal use as a reference, for example, when a staff member climbs the steps 201 or pulls the puller in a face-to-face posture, the steps 201 or the puller is oriented towards or close to the staff member's end as the front end, the back-to-personnel end as the back end, and the left and right direction is based on the left and right directions of the user when boarding the ladder or pushing the platform, and the same is also based on the horizontal direction in this application.

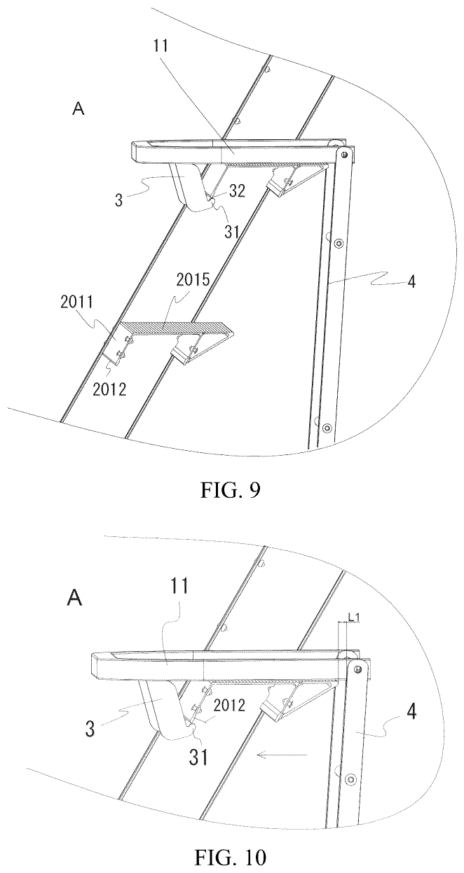

When this platform lifting and moving mechanism 100 is located in the working state (A state in FIG. 9 and FIG. 10) of movably carrying the platform, the connecting rod 4 and the rear end of the step 201 are spaced apart by a predetermined distance L1; the predetermined distance L1 being the maximum distance that the puller assembly 1 is allowed to be pulled forwards in the working state. In the working state, the length of the hooking portion 31 positioned below the step 201 is less than the predetermined distance L1. Taking the length of the hooking portion 31 located below the step 201 as L2, wherein L1 is greater than L2.

The puller assembly 1 has a rotatable angle range of greater than 90 degrees relative to the connecting rod 4. Specifically, the puller assembly 1 comprises a left and right armrest bar 11 and a center puller 12, and a rear end 111 of the left and right armrest bar 11 is rotatably connected to an upper end of the connecting rod 4. The upper end of the connecting rod 4 is connected to the rear end of the armrest bar 11 by a pivot shaft 112. The connecting rod 4 has a cross-section in the shape of “L”, and the pivot shaft 112 simultaneously runs through the upper end of the connecting rod 4 and the rear end of the armrest bar 11 to form a rotational connection. The left and right armrest bar 11 is transversely arranged on the left and right sides of the handrail, and the whole is in the form of a U-shape.

The platform connecting frame 5a and the lifting base frame 5b are connected to each other by an intermediate connector. The two ends of the intermediate connector are rotationally connected to the platform connecting frame 5a and the lifting base frame 5b respectively. The length of the force arm of the connecting rod 4 is more than 3 times the length of the force arm of the intermediate connector, preferably 5±2 times. Specifically, between the platform connecting frame 5a and the lifting base frame 5b, two intermediate connectors are provided in front and rear, and the two intermediate connectors are set parallel to each other and are respectively connected to the front end of the platform connecting frame 5a, the front end of the lifting base frame 5b, and the rear end of the platform connecting frame 5a, the rear end of the lifting base frame 5b, to form the parallel four-link structure. In FIG. 1, the lower end of the connecting rod 4 is fixedly connected to the front intermediate connector. The rolling member is a universal wheel, including two front universal wheels 8 and two rear universal wheels 7. The intermediate connector is a connecting pair of plates, the upper and lower ends of which are rotationally connected to the platform connecting frame 5a and the lifting base frame 5b respectively, the front connecting pair of plates is located on the front side of the rear connecting pair of plates 6, and one of the plates in the front connecting pair of plates is a flat plate 9, and the other plate is an L-type plate 10, and the L-type plate 10 is fixedly connected to the lower end of the connecting rod 4, so that the connecting rod 4 moves together with this front connecting pair of plates.

Of course, the lifting body, the puller assembly 1, the platform connecting frame 5a, the lifting base frame 5b, and the rolling member in this embodiment can be referred to the description of the prior application of a mechanism for platform lifting control and a lifting platform in the Chinese utility model patent “CN217297113U”, and the repetition will not be repeated.

When the handle assembly 1 is in the working state (A state), the angle between the connecting rod 4 and the plane in which the platform connecting frame 5a is located is greater than 60 degrees and less than 90 degrees. When the puller assembly 1 moves to the unlocking state (B state), the angle between the connecting rod 4 and the plane in which the platform connecting frame 5a is located is less than or equal to 90 degrees. By lifting the puller assembly 1 in the unlocking state by rotating in the direction f to, for example, C state as shown, the user simply unlocks the locking member 3 to the C state, where the platform's own weight will help pull the puller assembly 1 back, and the swivel bar will rotate on its own in the direction g.

In this embodiment, the locking member 3 is provided on the puller assembly 1, which can be blocked by the front end of the step of the platform to maintain the working state of the platform lifting and moving mechanism to carry the platform. The locking member 3 comprises a locking plate; the hooking portion 31 is an inner hook body provided at the lower end of the locking plate; the locking plate and the inner hook body are of one-piece molded structure. The locking plate is fixedly connected inwardly inclined to the underside of the puller assembly 1; a narrow side of the locking plate faces the steps 201. Multiple locking plates are distributed in a left-right manner. The inner hook body extends inwardly and upwardly diagonally at the lower end of the locking plate to form a downwardly concave groove with the locking plate.

Two connecting rods 4 are provided in parallel and rotationally connected to the two rear ends of the puller assembly 1 respectively. In order to improve the structural integrity of the platform lifting and moving mechanism 100 and avoid the problem of unsynchronized lifting of the moving wheels on both sides, the platform lifting and moving mechanism 100 is further provided with reinforcing connecting rods; two ends of the reinforcing connecting rod are fixedly connected to the two connecting rods 4 respectively. The reinforcing connecting rod and the connecting rod 4 are perpendicular to each other. To further strengthen the structural strength, multiple reinforcing connecting rods are fixedly connected in parallel between the two connecting rods 4.

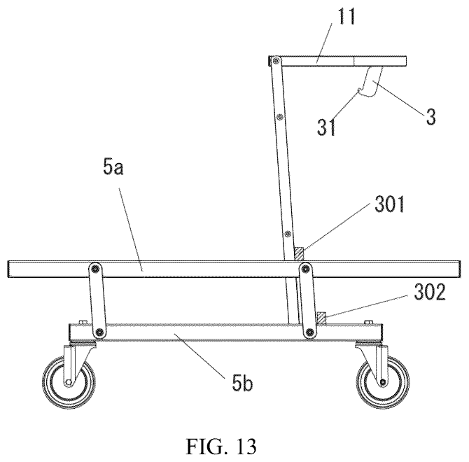

As shown in FIG. 13, in another preferred embodiment, the platform lifting and moving mechanism 100 is further provided with a limiting member; the limiting member is configured so that the angle between the connecting rods 4 and the plane where the platform connecting frame 5a is located does not exceed 90 degrees. The limiting member comprises a first limiting stop bar 301 fixedly connected to the platform connecting frame 5a, the first limiting stop bar 301 being located on the front side of the connecting rod 4, limiting and stopping the connecting rod 4. The connecting rod 4 is limited when it is rotated until it comes into contact with the first limiting stop bar 301, at which point the angle between the connecting rod 4 and the plane in which the platform connecting frame 5a is located is no more than 90 degrees, and the puller assembly 1 is located in the highest position. For example, when the connecting rod 4 is limit-stopped by the first limiting stop bar 301, the angle between the connecting rod 4 and the plane in which the platform connecting frame 5a is located may be 85 degrees, 86 degrees, 87 degrees, or 90 degrees, and so on.

In other embodiments, the limiting member comprises a second limiting stop bar 302 fixedly connected to the lifting base frame 5b. The second limiting stop bar 302 is located on the front side of the intermediate connector, limiting and stopping the intermediate connector so as to limit the connecting rod 4 to an angle of no more than 90 degrees to the plane in which the platform connecting frame 5a is located.

By setting the limiting member, the maximum rotation angle of the connecting rod 4 can be limited, and thus the maximum standing height of the connecting rod 4 can be limited, which can not only adapt to the different heights of the steps 201, but also avoid the connecting rod 4 from being over-turned (exceeding 90 degrees). When the connecting rod 4 is over-turned, the weight of the platform will prompt the connecting rod 4 to continue to lie forward and it is difficult to retreat, and even if the staff unlock the locking member 3, they still need to push the puller assembly 1 to overcome the weight of the platform, which is a high work intensity; and by setting the limiting member, the angle between the connecting rod 4 and the plane in which the platform connecting frame 5a is located is not more than 90 degrees, and thus the weight of the platform will help the puller assembly 1 to retreat, and the user only needs to unlock the locking member 3. In addition, by means of the setting of the limiting member, the user can directly pull the platform lifting and moving mechanism 100 forward in the unloaded state in the state shown in FIG. 13.

As shown in FIG. 6, in another embodiment of the present application, a combined platform is also provided, which comprises: a platform, the platform comprising multi-level steps; and a platform lifting and moving mechanism. Wherein, the platform lifting and moving mechanism adopts the platform lifting and moving mechanism 100 described in the above embodiment, which will not be repeated herein.

In addition, the combined platform provided in this embodiment has a standing portion, a fence portion, and other portions (e.g., a ladder leg frame portion) of the platform may be selected from any suitable existing construction. In order to clearly and briefly illustrate the technical solution provided by the present embodiment, the above portions will not be repeated herein.

The platform takes the A-frame ladder 200 as an example, the A-frame ladder 200 has a plurality of steps 201 between the two ladder legs, and the platform lifting and moving mechanism 100 is placed inside the A-frame ladder 200 and fixedly connected the lifting body to underneath the A-frame ladder 200 by bolts or a plurality of connecting strips. The front end 2011 of the step 201 is a front-end plate, and the upper end is a step surface 2015 for stepping. At this time, the connecting rod 4 together with the puller assembly 1 is in a lying state, and the rolling member as well as the lifting base frame 5b are in a lifting state, and are not performing the support of the platform. When it is necessary to support the mobile platform, the staff pulls the connecting rod 4 forward by pulling the puller assembly 1 forward to rotate it, and the lifting base frame 5b drives the rolling member to descend and pan together until it contacts the ground, and with the further pulling of the staff, the rolling member needs to descend further relative to the platform, and the platform is lifted relative to the platform through the ground support. The platform is lifted to the highest height, at which time the connecting rod 4 contacts with the limiting member or the rear end of the step 201 contacts with the connecting rod 4, and the puller assembly 1 is flipped downward to the puller assembly 1 being carried by the step surface 2015 of the step 201, and the puller assembly 1 is limited by the step 201 from being able to continue to be flipped downward, and at this time, after the unloading of the puller assembly 1, the locking member 3 of the puller assembly 1 will be hooked to the front-end plate of the step 201, and the inner hook body is located under the lower end 2012 of the front-end plate, to complete the lifting and positioning of the platform.

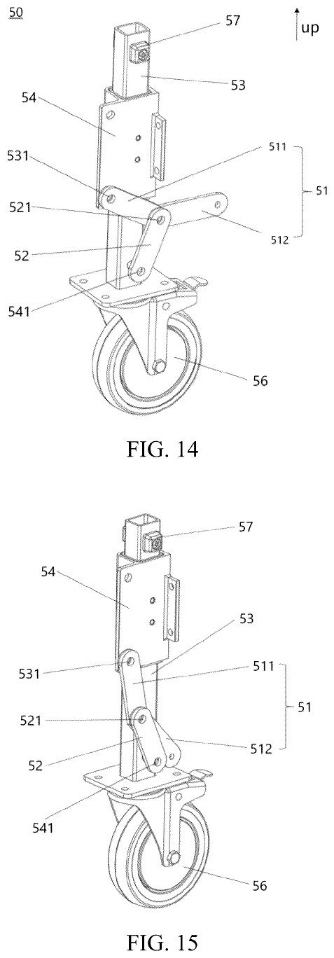

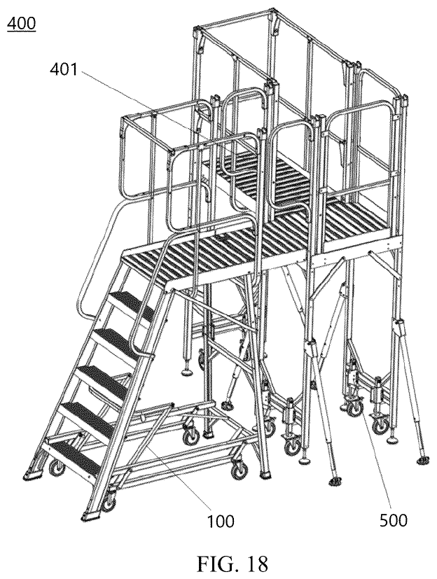

As shown in FIG. 14 to FIG. 18, as shown in FIG. 14, an embodiment of the present application provides a lifting mechanism 500 for the platform, the lifting mechanism 500 comprising a lifting assembly 50, the lifting assembly 50 being connected underneath the platform 401 (refer to FIG. 18) that needs to be lifted to realize the lifting of the platform 401. The lifting assembly 50 includes a first connecting rod 51, a second connecting rod 52, a sliding rod 53, and a slider 54. The slider 54 is movably socketed on the sliding rod 53, and the slider 54 may be provided with a connecting block for connecting with the platform 401. The first connecting rod 51 comprises a first rod body 511 and a second rod body 512. One end of the first rod body 511 is fixedly connected to one end of the second rod body 512 at a corner connection point 521, and the angle between the first rod body 511 and the second rod body 512 is obtuse. The other end of the first rod body 511 is rotationally connected to the slider 54 at a first rotation connection point 531. One end of the second connecting rod 52 is rotationally connected with the corner connection point 521. The other end of the second connecting rod 52 is rotationally connected with the sliding rod 53 at a second rotation connection point 541, and the second rotation connection point 541 is located below the slider 54. The second connecting rod 52 is located on the outer side of the obtuse angle formed by the first rod body 511 and the second rod body 512. The outer side of the obtuse angle can be understood as the side where the angle interposed between the first rod body 511 and the second rod body 512 is greater than 180°.

In use, the other end (the free end in FIG. 14) of the second rod body 512 is pressed down by an external force, at which time, the other end of the second rod body 512 drives the first rod body 511 and the second connecting rod 52 to rotate respectively, and the first connecting rod 51, when rotating, drives the slider 54 to slide upwardly along the sliding rod 53, which in turn can lift upwardly the platform 401 (see in FIG. 18) that is fixedly connected to the slider 54. The lifting mechanism 500 adopts the simplest hinge mechanism, which is simple and reliable, and saves effort.

Preferably, the lifting assembly 50 may include a locking structure, and the locking structure may include a pin, a locking bolt, and so on. When the lifting mechanism 500 lifts the platform 401 (see in FIG. 18) upwardly to a desired height, the position of the slider 54 with respect to the sliding rod 53 is secured by the locking structure. As an example only, the second rod body 512 may be provided with a locking hole (not shown in the figure), and the sliding rod 53 may be provided with a locking strip (not shown in the figure), with a locking through groove provided on the locking strip. The length direction of the locking through groove is consistent with the movement trajectory of the locking hole during rotation of the second rod body 512. When the lifting mechanism 500 lifts the platform 401 upwardly to a demanded height, the locking hole is connected to the locking through groove at a corresponding position (the position of the locking hole relative to the locking through groove when the platform 401 is at the demanded height) by means of a bolt or a pin.

As shown in FIG. 15, when the other end of the second rod body 512 is pushed, the slider 54 moves upwardly along the sliding rod 53, thereby lifting the platform 401 (see in FIG. 18), and the slider 54 is lifted to the highest position when the corner connection point 521, the first rotation connection point 531 and the second rotation connection point 541 form a straight line. When the corner connection point 521 moves from one side of the line between the first rotation connection point 531 and the second rotation connection point 541 to the other side of the line, the rotation of the first connecting rod 51 and the rotation of the second connecting rod 52 are locked by gravity of the slider 54 and the platform 401 that is secured to the slider 54. By self-locking by gravity, the platform 401 is kept in a stable lifting state, which facilitates operation at a later stage. With the above design, when only the platform 401 needs to be lifted to a specified height, other locking structures can be dispensed with to make the lifting mechanism for the platform simple in structure and reliable in locking.

As shown in FIG. 14 and FIG. 15, the length sum of the first rod body 511 and the second rod body 512 of the first connecting rod 51 is greater than or equal to two times the length of the second connecting rod 52. The length of the first rod body 511 is 70 mm, the length of the second rod body 512 is 76 mm, and the length of the second connecting rod 52 is 60 mm. The angle between the first rod body 511 and the second rod body 512 of the first connecting rod 51 is 120°-160°. Further, the angle between the first rod body 511 and the second rod body 512 of the first connecting rod 51 is 150°. The greater the angle between the first rod body 511 and the second rod body 512, the more labor-saving it is.

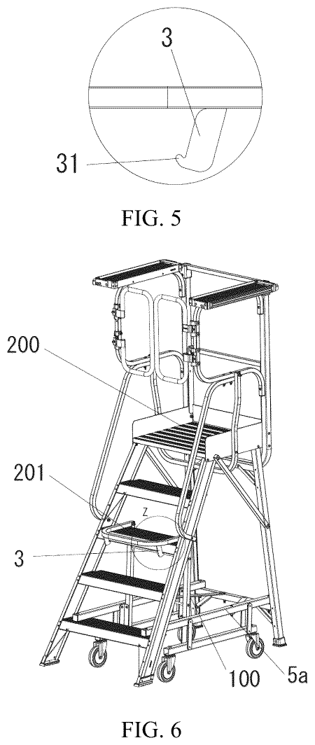

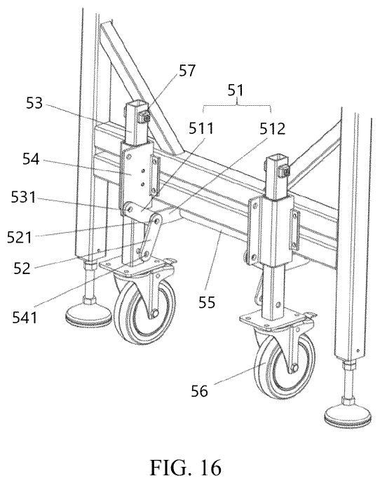

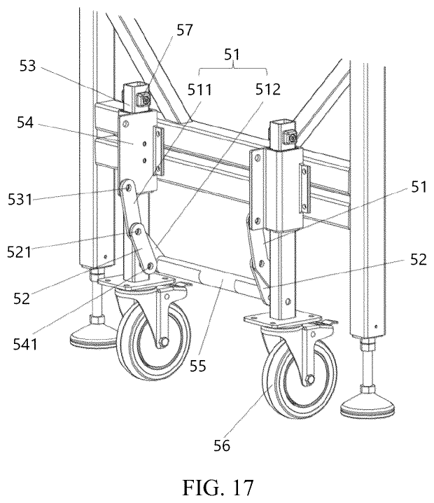

As shown in FIG. 16 and FIG. 17, the lifting mechanism 500 comprises at least two lifting assemblies 50. The lifting mechanism 500 further comprises a stepping rod 55. The stepping rod 55 is fixedly connected to the other end of the second rod body 512 in each of the lifting assemblies 50. The structure is set up so that only an external force is required to manipulate one stepping rod 55 to be pressed down to control the at least two sliders 54 of the at least two lifting assemblies 50 to slide upwardly along the sliding rods 53, thereby realizing the lifting of the platform 401. The at least two sliders 54 are fixedly connected to the platform 401 to be lifted at the same time to ensure that the platform 401 is more stable when it is lifted. As in the embodiments shown in FIG. 4 and FIG. 5, the lifting mechanism 500 includes two lifting assemblies 50. In other embodiments, the lifting mechanism 500 may include a greater number of the same lifting assemblies 50, for example, three, four, six, and so on. The number of lifting assemblies 50 may be selected based on the size of the platform 401 to be lifted.

As shown in FIG. 14 to FIG. 18, the lifting assembly 50 further includes casters 56. The casters 56 are fixedly connected to a lower end portion of the sliding rod 53. The sliding rod 53 is provided with a limit structure 17, and the slider 54 is set on the sliding rod 53 to slide upwardly and downwardly along the sliding rod 53, and the limit structure 17 is used to limit the limit position of the upward movement of the slider 54.

When the lifting assembly 50 lifts the platform 401 (see in FIG. 18) overall elevation above ground, the bottom support feet of the platform 401 are no longer in contact with the ground, and the casters 56 can be rolled to realize horizontal movement of the platform 401. In some embodiments, the casters 56 include universal wheels, and the universal wheels realize that the platform 401 can be moved in any direction horizontally after the platform 401 is lifted. The casters 56 all adopt universal wheels, so that after the platform 401 is lifted, manpower can push the platform 401 to realize the platform 401 to move in any direction horizontally. The combined large platform is used in many climbing scenes, but it is basically fixed, mainly because of its large size and heavy weight and difficult to realize the horizontal direction of movement. The lifting mechanism 500 provided with casters 56 can be applied to lift the combined large platform, which effectively solves the problem of the difficulty of moving the combined large platform on the ground, and the lifting mechanism 500 can lift the combined large platform elevation above ground, thereby realizing that the casters 56 roll in vertical force contact with the ground, and realizing that the combined large platform with a large volume and a heavy weight can be moved in an arbitrary horizontal direction on the ground.

As shown in FIG. 17, the embodiments of the present application also provide a combined platform 400, the combined platform 400 includes a platform 401 and a lifting mechanism for the platform, and a platform lifting and moving mechanism. Among them, the platform 401 may include an elevated working platform such as a A-frame ladder, a scaffold, or the like. The lifting mechanism for the platform, the platform lifting and moving mechanism adopts the lifting mechanism 500 and the platform lifting and moving mechanism 100 described in the above embodiments, which can work together to lift the platform 401, and the repetitions will not be repeated.

Specifically, the slider 54 of the lifting mechanism 500 is fixedly connected to the platform 401. For example, the slider 54 may be fixedly connected to a support member of the platform 401. The lifting mechanism 500 is used to lift the platform 401 to achieve raising the height of the platform 401 to the ground. In some embodiments, the platform 401 comprises a combined scaffolding (which may also be other types of ladders and large platforms), and a plurality of lifting mechanisms 500 may be fixedly connected to the underside of the platform 401 according to the needs to ensure the stability of the entire combined platform 400 when it is lifted. In some embodiments, as shown in FIG. 18, three lifting mechanisms 500 are fixed below the combined platform 400, and the three lifting mechanisms 500 may be distributed in a triangular shape to ensure that the platform 401 can be lifted stably. The three lifting mechanisms 500 may also be distributed in other ways, such as isosceles triangles, equilateral triangles, and the like. In some embodiments, four lifting mechanisms 500 may also be fixedly connected below the combined platform 400 as required, and the four lifting mechanisms 500 may be distributed in a rectangular shape.

The combined platform 400 includes a plurality of lifting mechanisms 500. Among the plurality of lifting mechanisms 500, there is a main lifting mechanism and other sub-lifting mechanisms. The number of lift drive mechanisms is the same as the number of sub-lifting mechanisms. That is, each of the sub-lifting mechanisms may be driven by the lift drive mechanism to lift the platform. As shown in FIG. 18, the combined platform 400 includes three lifting mechanisms 500, one of which may be the main lifting mechanism and the other two of which may be the sub-lifting mechanisms.

Beneficial effects that may be brought about by the embodiments of this application include, but are not limited to: 1) the first connecting rod rotates the second connecting rod and then drives the slider to move up to realize the platform lifting, the use of leverage principle, the vertical lifting platform is convenient and labor-saving, and manpower can be used to achieve vertical lifting of the large platform as a whole; 2) the lifting mechanism will elevate the platform to the height above the ground, and then achieve the casters and the ground of the vertical force contact and rolling, thus realizing the platform horizontal; 3) the gravity locking structure of the lifting assembly is simple, which makes that when the platform is in the lifting state, the efficiency of working by using the platform is improved; 4) the casters all adopt universal wheels, which realizes that after lifting the horizontal in any direction can be pushed to move by human force.

It is to be understood that the above description is intended to be illustrative, and not restrictive. Many embodiments and many applications other than the examples provided will be apparent to those skilled in the art upon reading the above description. Therefore, the scope of the present teachings should not be determined by reference to the above description, but should be determined by reference to the entire scope of the attached claims and their equivalents. For comprehensive purposes, all articles and references, including patent applications and announcements, are incorporated by reference in this article. Omitting any aspect of the disclosed subject matter in the aforementioned claims is not intended to abandon the subject matter, nor should it be considered that the inventor did not consider the subject matter as part of the disclosed invention subject matter.

1. A platform lifting and moving mechanism, a platform comprising multi-level steps; the platform lifting and moving mechanism comprising:
a lifting body for fixedly connecting the platform, which is provided with a parallel four-link structure and a rolling member;
a puller assembly connected to the lifting body; the puller assembly being maneuverable to raise or lower the rolling member via the parallel four-link structure; wherein the puller assembly also has a locking member fixedly connected to the front end of the puller assembly; the upper end of the locking member being fixedly connected to the puller assembly; and wherein the locking member is capable of being blocked by the front end of the platform's steps in order to maintain a working state in which the platform lifting and moving mechanism carries the platform.

2. The platform lifting and moving mechanism according to claim 1, wherein the locking member is fixedly connected to the puller assembly at its upper end and is provided with a hooking portion at its lower end;
wherein the platform lifting and moving mechanism is in the working state in which the platform is movably carried, the locking member is blocked from contact with the front end of the steps, and the hooking portion is located below the front end of the steps; the puller assembly in such working state is permitted to be pulled forward a predetermined distance in order to move the hooking portion out from underneath the steps to an unobstructed unlocking state; when the hooking portion is in the unlocking state, the puller assembly is allowed to be maneuverable to rotate upwards.

3. The platform lifting and moving mechanism according to claim 2, wherein the locking member comprises a locking plate; the hooking portion is an inner hook body provided at a lower end of the locking plate; the locking plate and the inner hook body are of one-piece molded construction; and an upper end of the locking plate is welded to the puller assembly.

4. The platform lifting and moving mechanism according to claim 3, wherein the locking plate is fixedly connected inwardly inclined to the underside of the puller assembly; a narrow side of the locking plate faces the steps; the inner hook body extends inwardly and upwardly diagonally at the lower end of the locking plate to form a downwardly concave groove with the locking plate.

5. The platform lifting and moving mechanism according to claim 2, wherein the lifting body comprises: a platform connecting frame for fixedly connecting the platform and a lifting base frame connected in parallel below the platform connecting frame; the lifting base frame is provided with the rolling member; the puller assembly is connected to the lifting body via a connecting rod; the rear end of the puller assembly is rotatably connected to the upper end of the connecting rod; the puller assembly has a rotatable angular range of greater than 90 degrees relative to the connecting rod.

6. The platform lifting and moving mechanism according to claim 5, wherein the platform lifting and moving mechanism is located in the working state of movably carrying the platform, with the connecting rod and the rear end of the steps spaced a predetermined distance apart, and length of the hooking portion below the steps is less than the predetermined distance.

7. The platform lifting and moving mechanism according to claim 5, wherein the angle between the connecting rod and the plane in which the platform connecting frame is located is greater than 60 degrees and less than 90 degrees when the puller assembly is in the working state; and when the puller assembly is moved to the unlocking state, the angle between the connecting rod and the plane in which the platform connecting frame is located is less than or equal to 90 degrees, and greater than the angle between the connecting rod and the plane in which the platform connecting frame is located in the working state.

8. The platform lifting and moving mechanism according to claim 7, wherein two connecting rods are provided in parallel, and rotationally connected to two rear ends of the puller assembly respectively;
the platform lifting and moving mechanism is further provided with one or more reinforcing connecting rods; two ends of the reinforcing connecting rod are each vertically fixedly connected to the two connecting rods.

9. The platform lifting and moving mechanism according to claim 5, wherein the platform lifting and moving mechanism is further provided with a limiting member; the limiting member being configured so that the connecting rods do not make an angle of more than 90 degrees with the plane in which the platform connecting frame is located.

10. A combined platform, wherein, comprising:
a platform, the platform comprising multi-level steps;
a platform lifting and moving mechanism, the platform lifting and moving mechanism comprising:
a lifting body fixedly connected to the platform, which is provided with a parallel four-link structure and a rolling member;
a puller assembly connected to the lifting body; the puller assembly being maneuverable to raise or lower the rolling member via the parallel four-link structure; wherein the puller assembly also has a locking member fixedly connected to the front end of the puller assembly; the locking member being capable of being blocked by the front end of the platform's steps in order to maintain a working state in which the platform lifting and moving mechanism carries the platform.

11. The combined platform according to claim 10, wherein a lifting mechanism for the platform is also included;
the lifting mechanism comprises a lifting assembly; the lifting assembly comprises a first connecting rod, a second connecting rod, a sliding rod and a slider;
the slider is movably socketed on the slider rod; the slider is for connecting with the platform;
the first connecting rod comprises a first rod body and a second rod body; one end of the first rod body is fixedly connected to one end of the second rod body at a corner connection point, and the angle between the first rod body and the second rod body is obtuse; the other end of the first rod body is rotationally connected to the slider at a first rotation connection point;
one end of the second connecting rod is rotationally connected with the corner connection point; the other end of the second connecting rod is rotationally connected with the sliding rod at a second rotation connection point, and the second rotation connection point is located below the slider; the second connecting rod is located on the outer side of the obtuse angle formed by the first rod body and the second rod body; when the other end of the second rod body is rotated under the impetus of an external force, the slider will be driven to slide upward along the sliding rod, thereby driving the platform to rise.

12. The combined platform according to claim 11, wherein when the other end of the second rod body is pushed, the corner connection point moves from one side of a line connecting the first rotation connection point with the second rotation connection point to the other side of the line, and the slider moves upwardly with respect to the sliding rod, thereby raising the platform, and the rotation of the first connecting rod as well as the rotation of the second connecting rod are locked by gravity.

13. The combined platform according to claim 11, wherein the lifting mechanism comprises at least two of the lifting assemblies; the lifting mechanism further comprising a stepping rod; the stepping rod being fixedly coupled to the other end of the second rod body in each of the lifting assemblies.

14. The combined platform according to claim 11, wherein the lifting assembly further comprises casters; the casters are fixedly connected to a lower end of the sliding rod; the casters are universal wheels.
